(19) United States
(12) Patent Application Publication
(10) Pub. No.: US 2019/0082728 A1
(43) Pub. Date: Mar. 21, 2019

(54) Non-Processed Protein-based Nutritional Edible Substance

(71) Applicant: Great Food Designs Inc., Colorado Springs, CO (US)

(72) Inventor: Edward Scott Eaton, Colorado Springs, CO (US)

(21) Appl. No.: 16/136,097

(22) Filed: Sep. 19, 2018

Related U.S. Application Data
(60) Provisional application No. 62/560,518, filed on Sep. 19, 2017.

(51) Int. Cl. A23L 33/185; A23L 11/00; A23L 29/00; A23G 1/30

(52) U.S. Cl. CPC A23L 33/185; A23L 11/05; A23L 29/035; A23G 1/30; A23V 2300/31; A23V 2200/328; A23V 2200/332; A23V 2250/548; A23V 2002/00

(57) ABSTRACT

A non-processed protein-based nutritional edible substance for providing protein to a consumer. The non-processed protein-based nutritional edible substance includes a quantity of sunflower seeds, a quantity of pumpkin seeds, and a quantity of sweet binding compound. The sunflower seeds and the pumpkin seeds are the primary source for protein and beneficial nutrients. The quantity of sunflower seeds, the quantity of pumpkin seeds, and the quantity of sweet binding compound is heterogeneously mixed into a nutritional mixture, which allows the non-processed protein-based nutritional edible substance to be easily consumed by a person. The nutritional mixture can include additional quantities of ingredients to enhance the flavor, nutrients, protein quantity of the non-processed protein-based nutritional edible substance and/or to provide a recreational/medicinal effect to the consumer.

The current application claims a priority to the U.S. Provisional Patent application Ser. No. 62/560,518 filed on Sep. 19, 2017.

### FIELD OF THE INVENTION

The present invention relates generally to mixtures for nutritional edible substances. Specifically, the present invention is a mixture for a nutritional edible substance that is high in non-processed protein, and the method for attaining the nutritional edible substance.

### BACKGROUND OF THE INVENTION

In today's time, modern medicine has advanced to a point where the general public is capable of understanding what is necessary to maintain a healthy and balanced lifestyle. Nowadays, it is easier for the general public to obtain comprehensive information regarding their health and make informed decisions about their health. Not only is it easier these days, it also can be simple and inexpensive for the general public to become healthy. The general public understands that the roadway to becoming healthier requires eating healthier and exercising regularly. Although most individuals may have difficulty exercising regularly, most individuals have no difficulty in eating healthier. Even though there is the common means of eating healthier such as consuming more quantities of green vegetables, some individuals may also include consuming meal replacement bars, nutrition bars, or other similar nutritional edible substances. This practice might be more prevalent to individuals who find themselves needing more energy or vitamins, such as while exercising in a gym. Also, individuals who are trying to control their diet and/or eating habits, in order to lose weight or reduce the impact of diabetes, might need to rely on meal replacement bars, nutritional bars, or other similar nutritional edible substances in order to curb their appetite during the day.

There exists a plethora of meal replacement bars, nutritional bars, and other similar nutritional edible substances currently available on the market. Many of these nutritional edible substances are useful in providing a wide variety of health-related benefits. The most common health-related benefit of these edible substances is a high source of protein. A majority of these nutritional edible substances rely on wheat, oats, and other similar grain-like edible substances to provide high-protein content. However, a majority of grain-based edible substances provide high-protein content in the form of gluten, which can be harmful to individuals who are allergic to gluten. Some nutritional edible substances utilize tree nuts. Tree nut-related substances could include, but are not limited to, the following: almonds, walnuts, other legumes like peanuts, cashews, sesame seeds, or pistachios as the primary source of high-protein content. However, a majority of people are severely allergic to these tree nuts and edible substances made in the proximity of where tree nuts are processed. To provide a high-protein edible nutritional substance for individuals allergic to gluten and/or tree nuts, companies try to provide high-protein content from highly processed substances such as whey protein; however, highly processed substances are considered to be very unhealthy and risky to consume for most individuals. They can also acquire a negative taste over time. Instead, other uncommon natural ingredients that contain high-protein content must be utilized while retaining a uniquely good taste for users. For individuals who are allergic to tree nuts and/or gluten and are trying to avoid highly-processed protein sources, there exists a need for a meal replacement bar, nutritional bar, or other similar nutritional edible substance that does not contain a source of tree nuts, legumes, gluten, highly-processed protein, or any combination of these ingredients while still remaining uniquely good tasting.

An objective of the present invention is to provide users with a mixture for a nutritional bar, meal replacement bar, or other similar nutritional edible substances that do not contain any tree nut-related, legume nut-related, gluten-related, or highly processed protein-based ingredients as a major ingredient in the present invention. The present invention utilizes a combination of sunflower seeds and pumpkin seeds as the primary ingredients in the mixture of the nutritional bar, meal replacement bar, or other similar nutritional edible substance of the present invention. The present invention resolves the issues associated with the prior arts discussed in the previous paragraph. The present invention is much safer to consume for individuals who are allergic to tree nuts, and/or gluten because the present invention does not contain tree-nuts and/or gluten-based substances as the primary ingredient(s) of the mixture of the present invention. Additionally, the present invention does not utilize any highly-processed edible substances to provide a high-protein content for the mixture of the present invention. Also, the process, or method, of obtaining the mixture of the present invention is not a highly-processed method or process; therefore, keeping all ingredients involved in the making of the mixture of the present invention as natural as possible while reducing or eliminating the processing of the ingredients of the mixture of the present invention during the mixture method. Finally, through the combination of sunflower seeds and pumpkin seeds, the present invention, when mixed and finalized, retains a unique and good taste for the user while still providing an unprocessed source of high-protein without the ingredients that are common food allergies and/or risky for most people.

### DETAIL DESCRIPTIONS OF THE INVENTION

All illustrations of the drawings are for the purpose of describing selected versions of the present invention and are not intended to limit the scope of the present invention.

The present invention is a non-processed protein-based nutritional edible substance for providing protein to a consumer. The present invention sets out primarily to provide users with a healthy, non-processed, non-allergic source of high-protein while still providing users with a uniquely good and favorable natural taste. The present invention comprises a quantity of sunflower seeds, a quantity of pumpkin seeds, and a quantity of sweet binding compound. The sunflower seeds and the pumpkin seeds are the primary source of high-protein content, beneficial nutrients, and transition metals or transition metal compounds. In more detail, the transition metals or transition metal compounds, provided by the sunflower seeds and the pumpkin seeds, can include, but not limited to, chromium, cobalt, or iron. The sweet binding compound is used to bind the pumpkin seeds and the sunflower seeds. The sweet binding compound is preferably a sugar-based binder. Alternatively, the sweet binding compound can be a honey-based binder or a fruit-based binder. The quantity of sunflower seeds, the quantity of pumpkin seeds, and the quantity of sweet binding compound is heterogeneously mixed into a nutritional mixture, which allows the present invention to be easily consumed by a person. The nutritional mixture is preferably in the form of, but not limited to, a nutritional bar, meal replacement bar, or other similar nutritional, edible substance.

The quantity of sunflower seeds is a first percent volume (vol %) of the nutritional mixture and the quantity of pumpkin seeds is a second vol % of the nutritional mixture. The first vol % is equal to the second vol %. In further detail, the nutritional mixture preferably includes equal parts of sunflower seeds and pumpkin seeds in order for the present invention to provide an equal distribution of the protein, transition metals, and transition metal compounds to the consumer. More specifically, the first vol % and the second vol % ranges between 60 to 90 vol % of the nutritional mixture. The sunflower seeds and the pumpkin seeds are the main ingredients of the present invention. As mentioned previously, the sweet binding compound is used to bind the sunflower seeds and the pumpkin seeds together, and thus the quantity of sweet binding compound ranges between 0.1 to 10 vol % of the nutritional mixture.

In alternative embodiments of the present invention, the nutritional mixture can include additional ingredients. These additional ingredients can be included in the nutritional mixture of the present invention for several reasons, such as enhancing the flavor of the present invention or providing additional health benefits not found in sunflower seeds and/or pumpkin seeds. In a first embodiment of the present invention, the present invention may further comprise a quantity of cannabinoids. The cannabinoids may be, but not limited to, marijuana in plant form, cannabidiol (CBD) or cannabis oil. Cannabinoids are used to enhance the flavor of the present invention. Additionally, cannabinoids are used to enhance the experience of the consumer by ingesting the cannabinoids within the present invention to receive a recreational and/or medicinal effect. The quantity of cannabinoids is heterogeneously mixed into the nutritional mixture. The recreational and/or medicinal effect does not require a high quantity of cannabinoids, and thus the quantity of cannabinoids ranges between 0.1 to 2 vol % of the nutritional mixture.

In another embodiment of the present invention, the present invention may further comprise a quantity of tree nuts. The tree nuts are used to enhance the flavor and texture of the present invention and to provide more protein and nutrients. The tree nuts can be, but not limited to, almonds, cashews, chestnuts, or pecans. The quantity of tree nuts is heterogeneously mixed into the nutritional mixture. More specifically, the quantity of tree nuts ranges between 10 to 20 vol % of the nutritional mixture in order to not overcome the sunflower seeds and pumpkin seeds within the nutritional mixture.

In another embodiment of the present invention, the present invention may further comprise a quantity of legumes. The legumes are used enhance the flavor of the present invention and to provide more protein and nutrients. The legumes can be, but not limited to, peanuts, soybeans, lentils, or tamarind. The quantity of legumes is heterogeneously mixed into the nutritional mixture. More specifically, the quantity of legumes ranges between 10 to 20 vol % of the nutritional mixture in order to not overcome the sunflower seeds and pumpkin seeds within the nutritional mixture.

In another embodiment of the present invention, the present invention may further comprise a quantity of high-protein substance. The quantity of high-protein substance is used to increase the protein quantity in the present invention. The high-protein substance can be, but is not limited to, quinoa or oats. The quantity of high-protein substance is heterogeneously mixed into the nutritional mixture. More specifically, the quantity of high-protein substance ranges between 10 to 20 vol % of the nutritional mixture in order to not overcome the sunflower seeds and pumpkin seeds within the nutritional mixture.

In another embodiment of the present invention, the present invention may further comprise a quantity of chocolate substance. The chocolate substance is used to enhance the flavor of the present invention. The chocolate substance can be, but not limited to, milk chocolate or dark chocolate. Additionally, sweetened or unsweetened nut butters like cashew butter, hazelnut butter and other similar butters fall into this category. The quantity of chocolate substance is heterogeneously mixed into the nutritional mixture. More specifically, the quantity of high-protein substance ranges between 10 to 20 vol % of the nutritional mixture in order to not overcome the sunflower seeds and pumpkin seeds within the nutritional mixture.

In another embodiment of the present invention, the quantity of sweet binding compound, the quantity of cannabinoids, the quantity of tree nuts, the quantity of legumes, the quantity of high-protein substance, and the quantity of chocolate substance is heterogeneously mixed into the nutritional mixture. In this embodiment, the first vol % and the second vol % is approximately 60 vol % of the nutritional mixture. The quantity of sweet binding compound is approximately 5 vol % of the nutritional mixture. The quantity of cannabinoids is approximately 2 vol % of the nutritional mixture. The quantity of the tree nuts, the quantity of legumes, the quantity of high-protein substance, and the quantity of chocolate substance is approximately 33 vol % of the nutritional mixture.

The present invention can be produced with the following method. In the first step, the ingredients are gathered. The second step requires all ingredients to be placed into an appropriately-sized container that would allow for easy mixing of the contents within said container. In the third step, the contents are mixed within the container. The contents within the container are mixed until these two following conditions are met. The first condition is that the contents of the container are between 180° F. and 200° F. The mixture should reach the preferred temperature range within ten to fifteen minutes of mixing of the ingredients into the nutritional mixture. If the user is utilizing a fruit-based binder as the sweet binding compound, instead of a sugar-based binder, the time and/or temperature required to mix the contents of the nutritional mixture would be reduced; therefore, the time required would be reduced for the nutritional mixture with a fruit-based binder. The second condition is that the uniformity and consistency of the nutritional mixture can be visually affirmed with the pumpkin seeds and sunflower seeds being evenly dispersed throughout the nutritional mixture within the container. Once these two conditions are met, the nutritional mixture is rolled out onto a cooking sheet or other usable flat surface to an appropriate height in the fourth step of the method to obtain the present invention. In the fifth step of the method, the nutritional mixture is cut into sections in a grid-like manner with the width and length of each section being appropriate and uniform for packaging purposes. However, prior to the fifth step, the nutritional mixture may be coated with the chocolate substance. Finally, in the sixth step, each section of the nutritional mixture is placed into an independent packaging of the present invention. However, prior to the sixth step, the nutritional mixture may be dipped into the chocolate substance.

Although the invention has been explained in relation to its preferred embodiment, it is to be understood that many other possible modifications and variations can be made without departing from the spirit and scope of the invention as hereinafter claimed.

What is claimed is:

1. A non-processed protein-based nutritional edible substance comprises:
a quantity of sunflower seeds;
a quantity of pumpkin seeds;
a quantity of sweet binding compound; and
the quantity of sunflower seeds, the quantity of pumpkin seeds, and the quantity of sweet binding compound being heterogeneously mixed into a nutritional mixture.

2. The non-processed protein-based nutritional edible substance as claimed in claim 1 comprises:
the quantity of sunflower seeds being a first percent volume (vol %) of the nutritional mixture;
the quantity of pumpkin seeds being a second vol % of the nutritional mixture; and
the first vol % being equal to the second vol %.

3. The non-processed protein-based nutritional edible substance as claimed in claim 2, wherein the first vol % and the second vol % ranging between 60 to 90 vol % of the nutritional mixture.

4. The non-processed protein-based nutritional edible substance as claimed in claim 1 comprises:
the quantity of sweet binding compound ranging between 0.1 to 10 vol % of the nutritional mixture.

5. The non-processed protein-based nutritional edible substance as claimed in claim 1 comprises:
a quantity of cannabinoids; and
the quantity of cannabinoids being heterogeneously mixed into the nutritional mixture.

6. The non-processed protein-based nutritional edible substance as claimed in claim 5 comprises:
the quantity of cannabinoids ranging between 0.1 to 2 vol % of the nutritional mixture.

7. The non-processed protein-based nutritional edible substance as claimed in claim 1 comprises:
a quantity of tree nuts; and
the quantity of tree nuts being heterogeneously mixed into the nutritional mixture.

8. The non-processed protein-based nutritional edible substance as claimed in claim 7 comprises:
the quantity of tree nuts ranging between 10 to 20 vol % of the nutritional mixture.

9. The non-processed protein-based nutritional edible substance as claimed in claim 1 comprises:
a quantity of legumes; and
the quantity of legumes being heterogeneously mixed into the nutritional mixture.

10. The non-processed protein-based nutritional edible substance as claimed in claim 9 comprises:
the quantity of legumes ranging between 10 to 20 vol % of the nutritional mixture.

11. The non-processed protein-based nutritional edible substance as claimed in claim 1 comprises:
a quantity of high-protein substance; and
the quantity of high-protein substance being heterogeneously mixed into the nutritional mixture.

12. The non-processed protein-based nutritional edible substance as claimed in claim 11 comprises:
the quantity of high-protein substance ranging between 10 to 20 vol % of the nutritional mixture.

13. The non-processed protein-based nutritional edible substance as claimed in claim 1 comprises:
a quantity of chocolate substance; and
the quantity of chocolate substance being heterogeneously mixed into the nutritional mixture.

14. The non-processed protein-based nutritional edible substance as claimed in claim 13 comprises:
the quantity of chocolate substance ranging between 10 to 20 vol % of the nutritional mixture.
